(19) United States
(12) Patent Application Publication
(10) Pub. No.: US 2006/0148980 A1
(43) Pub. Date: Jul. 6, 2006

(54) Waterborne self-crosslinkable polyurethane dispersions and polyurethane:acrylic hybrid dispersions

(76) Inventors: Michel Tielemans, Wemmel (BE); Dirk Bontinck, Ertvelde (BE); Vincent Renard, Couthuin (BE)

Correspondence Address: WENDEROTH, LIND & PONACK, L.L.P., 2033 K STREET N. W., SUITE 800, WASHINGTON, DC, 20006-1021, US

(21) Appl. No.: 10/560,505

(22) PCT Filed: Jul. 6, 2004
(86) PCT No.: PCT/EP04/07354

§ 371 Date: Dec. 30, 2005

(30) Foreign Application Priority Data
Jul. 14, 2003 (EP) 03015968.5

(51) Int. Cl. C08G 18/08

(52) U.S. Cl. 524/591

(57) ABSTRACT

The present invention concerns a hybrid polymer dispersion comprising a functionalized polyurethane polymer (A) and a functionalised vinyl polymer (B) either as individual particles or as composites particles wherein the polyurethane polymer is prepared in a high boiling point oxygenated coalescing solvent having no functional group reactive with isocyanates and that will remain after water dispersion.

The present invention concerns crosslinkable polyurethane dispersions to be used as an hybrid polymer dispersion in water, said hybrid polymer dispersion comprising a functionalized polyurethane polymer (A) and a functionalised vinyl polymer (B) either as individual particles or as composite particles

The growing concerns on ecological issues have lead to the development of coating technologies having a lesser chemical impact on occupational health and environment.

Waterborne coatings constitute a very big and Important category of products for the industry due to their ecological background. Intense research and development activities are ongoing in order to continue to positively impact the reduction of volatile organic compounds (VOC) like solvents and amines, but also the suppression of hazardous and ecotoxic components like some residual monomers, crosslinkers, emulsifiers, biocides, catalysts, etc.

Polyurethane dispersions (PUD) are a fast growing class of polymers that can respond to these ecological requirements while offering a premium performance with regard to the mechanical and chemical resistance it offers on many coated substrates. The development of hybrid technologies involving the use of these polyurethane dispersions are capable to address the higher initial cost of the parent polyurethane polymer and enhance the benefits from the several polymer backbones present due to self-crosslinking properties, without the need of an external crosslinker and the disagreement of a limited pot-life before use.

The hybrid chemistries involving polyurethane dispersions have been described many times. For instance the patent U.S. Pat. No. 5,541,251 describes an aqueous self-crosslinkable resin composition comprising an aqueous dispersion of at least one polyurethane polymer having anionic salt groups as sole chain-pendant functional group and at least one vinyl polymer having acetoacetoxyalkyl ester groups as lateral chains and capable of reacting with the polyurethane polymer during or after film formation, and resulting in the formation of a polymeric film having properties not found to be those of the non-functional components.

Among the most important properties requested for these waterborne dispersions are the good film formation at room temperature, and the rapid development of an optimum and non-evolutive coating hardness upon drying. This last requirement is not easily matched by the prior art.

The film formation has been a lot described, for example in “Mechanism of Film Formation from Polymer Latexes” from S. T. Eckersley, J. Coating Techn., 62, 780 (1990). It is generally admitted that the film formation happens in 3 consecutive stages: 1) water evaporation 2) capillary forces 3) particle coalescence. The particles coalescence imply the inter-diffusion of the polymer chains from two neighbour particles and was studied even in the more complicated case of the crosslinking of thermoset latex films, for example in M. A. Winnik, Journal of Coatings Technology, 74, 925, 49 (2002). A “minimum film formation temperature” (MFFT) can be determined experimentally, and constitutes an intrinsic characteristic of the polymer dispersion in water.

The drying of a waterborne coating includes the evaporation of water and the film formation from the polymer particles dispersed in water. The overall drying process of a coating can also be approached experimentally, generally by the means of slowly moving needles leaving a trace on the drying film. This method has been used a lot to study the drying of alkyds. 5 zones can be defined depending on the state of water evaporation during the film formation process: levelling>basic trace>ripped film>surface trace>dry film. This last point corresponds to the “open time” which is the time needed to reach an infinite viscosity. The drying time depends strongly on external factors (temperature, humidity, air flow, film thickness, skin formation . . . ), but the polymer dispersion characteristics are also important (water contents, polymer nature, additives); the open time was shown to be related to the “volume-to-mass ratio” influenced in turn by the polarity of the polymer at a given pH and by the presence of co-solvents. This phenomenon Is well described in a paper called “Rheological Changes during the Drying of a Waterborne Latex Coating”, F. Loflath, J. Coating Techn., 69, 867, 1997.

Two cases can be find practically for the coating of waterborne polymers.

At elevated temperature (coatings for industrial application), the open time will be reduced to the minute- or even the second-scale, depending on the film thickness and on the oven characteristics & residence time.

At room temperature (and even down to 5° C. for do-it-yourself applications), a good film formation is a prerequisite. The time scale involved for drying is around 1 hour, and this ‘open time’ measured with the ‘needle method’ Is irrelevant for the application (i.e. a few minutes difference does not make a real difference to the end user).

After the immediate drying process (open time), the film is freshly formed and exhibit a certain hardness—providing in turn a relative resistance to scratch, blocking and dust pick-up—as described in “Factors Affecting Dirt Pick-up in Latex Coatings”, A. Smith, J. Coating Techn., 68, 862, 1996. The time needed to reach a steady-state coating hardness at ambient temperature, and compatible with its usage is particularly relevant to the user. This property, called fast hardness, is referring to a coating which reaches rapidly an optimum and non-evolutive hardness. This is a very important requirement for do-it-yourself markets, since the user is supposed to make a normal usage of the coated substrate (f.i. wood) very rapidly after painting at room temperature (dust pick-up, blocking resistance, scratch and adhesion resistance). This phenomenon is best measured with a kinetics of pendulum hardness measurements (König, Persoz) and the time scale involved is in the range of 1 hour to 7 days.

The external parameters important to fast hardness are the temperature, the relative humidity and the coating thickness.

The state of the art does not particularly focus on the improvement of the fast hardness development although it is sometimes mentioned in some patents as one of the non-specific deliveries of the inventions. In most of the cases, the (final) hardness of the coatings from the prior art are linked to the (self)crosslinking with/without the implication of a (semi)interpenetrated network, and where air drying of the fatty acid compound may constitute a particular case. The balance between a good film formation (MFFT) and the rapid hardness obtained after (self)crosslinking at ambient temperature is most probably the main problem unsolved in the prior art, and that our invention aims to address with the specific usage of coalescing solvents in an original hybrid polymer composition.

The selection of solvents that remains during and after the drying of the film is a key parameter for fast hardness at ambient temperature. Indeed, it was found that the polymer nature (monomers, hardness, functionality, molecular weight, crossing) mainly play a role in the final hardness of the coating, rather than the hardness build-up kinetics.

The state-of-the-art process to make PUDs involves the use of N-methylpyrrolidone (NMP) as an excellent solvent for the polyurethane prepolymer synthesis; this solvent is a small polar molecule with a high boiling point (202° C., 760 mm Hg) and has a particularly good affinity for the polymer. In the normal process, the polyurethane prepolymer in NMP is neutralized and dispersed in water and the solvent is not stripped-off from the dispersion. A further advantage of the process rely in the fact that the process solvent serves as coalescing agent for the harder polymer dispersions and provides a good film formation.

Another state-of-the-art process uses acetone or methyl ethyl ketone in the same way as before, but the solvent is then easily stripped out of the polymer dispersion due to its lower boiling point (56° C., 760 mm Hg). In this case, the final dispersion is almost free of residual solvents. These dispersions provide a much better fast hardness development due to the absence of solvent. However, they might have a detrimentally higher minimum film forming temperature (MFFT) especially when applied at room temperature for do-it-yourself applications. In this case, a coalescing agent should be added to the dispersion to ensure the good film formation. Those coalescing agents are well known in the state-of-the-art, and are generally oxygenated solvent with a higher boiling point (ca 200° C., 760 mm Hg) like typically the (poly)glycol ethers and esters.

Surprisingly, it has been discovered that selected non reactive oxygenated coalescents could be used to replace the NMP in the synthesis process of the polyurethane oligomer, providing a polymer dispersion having at the same time an easy film formation and an improved fast hardness development, not obtained when the same coalescent is added to the polymer dispersion as a formulation, after the synthesis. The presence of the acetone or methyl ethyl ketone in the process is not mandatory.

This is why the coating compositions of the present invention are based on:

(A) a dispersion of a crosslinkable polyurethane polymer in aqueous medium, and obtainable from a polyurethane prepolymer which is the reaction product of:
(i) at least one polyisocyanate, and
(ii) at least one organic compound containing at least two reactive groups which can react with isocyanates, and
(iii) at least one compound which is capable to react with an isocyanate group and which contains at least one additional functional group which is susceptible either to dispersion in water and/or to a crosslinking reaction
(iv) in an oxygenated solvent selected from the coalescing agents having a higher boiling point of from 150 to 250° C., under 760 mm Hg and being chemically inert towards isocyanates during the manufacture of the polyurethane;
   the so obtained polyurethane prepolymer being further neutralised and dispersed in water, and optionally then reacted with a chain extender or capping agent (v) having or not remaining functional groups after the capping;

(B) a crosslinker which is a vinyl-type polymer having functional groups reactive with the functional groups of the polyurethane (A).

The oxygenated solvents (iv) can regroup not imitatively all those compounds responding to the basic criteria of coalescing efficiency and including water-to-polymer partitioning, evaporation rate, solvent retention, odor, color, freezing point, hydrolytic stability, biodegradability, irritancy and safety as described in the state of the art (see for instance Recent Advances in Coalescing Solvents for Water-Based Coatings, D. Randall, Polymers Paint & Color Journal, 188 (4405), 12, 14-15, 1998) The chemical inertness against the isocyanates and the ability to provide a fast hardness development upon drying and to improve of the final physico-chemical properties of the coating are both inherent to this invention.

The oxygenated solvent (iv) used in the present invention generally contains only carbon, hydrogen and oxygen atoms. The chemical categories of coalescing solvents (iv) responding to the above specifications include the oxygenated solvents with a balanced hydrophilic character that will tend to be preferentially sited at the particle/aqueous interface along with the surfactants, if any. They are usually selected from the fully reacted alkyl or aryl esters of aromatic, aliphatic or cycloaliphatic polycarboxylic acids, the fully reacted alkyl or aryl esters of aromatic, aliphatic or cycloaliphatic polyglycols, the fully reacted alkyl or aryl ethers of aromatic, aliphatic or cycloaliphatic polyglycols, the fully reacted mixed alkyl and aryl esters and ethers of mixed aromatic, aliphatic or cycloaliphatic polyglycol-carboxylates, the unsubstituted and alkyl and aryl substituted cyclic carbonates, the unsubstituted and alkyl and aryl substituted cyclic ethers, the unsubstituted and alkyl and aryl substituted cyclic esters, the unsubstituted and alkyl and aryl substituted cyclic anhydrides.

The coalescing solvents (iv) that are particularly suitable to be used in the frame of our invention are including not imitatively the dimethyl esters or diisobutyl esters of adipic, glutaric, succinic or phtalic acids and their blends, ethyl-3-ethoxypropionate (Ektapro EEP, Eastman), 2,2,4-trimethyl-1,3-pentanedioldiisobutirate (Kodaflex TXBI, Eastman), ethylene carbonate (Bp=248° C.), propylene carbonate (Bp=242° C.), propyleneglycol diacetate (DOWANOL PGDA, Bp=191° C., 760 mm Hg), dipropylene glycol dimethyl ether (PROGLYDE DMM, Bp 175° C., 760 mm Hg). The best coalescing solvent is also non irritating (Xi-free).

The coalescing solvents (iv) are generally used in an amount of 5 to 40 wt %, preferably 10 to 15 wt % expressed on the dry polymer, to reduce the viscosity of the prepolymer and, after dispersion in water, to ensure the good film formation and the fast hardness according to the invention.

This process may be facilitated by the addition of another optional low boiling point solvent, in order to further reduce the viscosity if this would appear to be necessary. Suitable solvents, either alone or in combination, are those belonging to ketones with a relatively low boiling point so that they can easily be removed before, during or after the chain extension by distillation under reduced pressure. Examples of such solvents include acetone, methyl ethyl ketone, diisopropyl ketone, methyl isobutyl ketone.

Advantages of the invention is the extremely good fast hardness development of the coating, associated with a low MFFT and a good performance profile (stain resistance, solvent resistance, etc)

Another advantage is the reduced level of the coalescing solvent necessary to get a workable viscosity suitable for dispersion in water.

The absence of any stripping operation of a process solvent is also an advantage, with a positive impact on productivity.

Finally, the use of a coalescing solvent is not necessarily irritating when compared with typical solvents used for making polyurethanes, such as N-methylpyrrolidone.

The preparation of the polyurethane prepolymer bearing terminal isocyanate moieties can be carried out in a conventional manner, by reacting a stoichiometric excess of the organic polyisocyanate(s) with all the organic compounds containing at least two reactive groups which are enabled to react with isocyanate groups under substantially anhydrous conditions, preferably at a temperature between 50° C. and 120° C., more preferably between 70° C. and 95° C., until the reaction Is complete. The reaction may be carried out in the presence of any of the known catalysts suitable for polyurethane preparation such as amines and organometallic compounds. Examples of these catalysts include triethylenediamine, N-ethyl-morpholine, triethylamine, dibutyltin dilaurate, stannous octanoate, dioctyltin diacetate, lead octanoate, stannous oleate, dibutyltin oxide and the like.

During the preparation of the isocyanate-terminated polyurethane prepolymer the reactants are generally used in proportions corresponding to an equivalent ratio of isocyanate groups to such groups which are enabled to react with the isocyanate functionalities of from about 1.1:1 to about 2:1, preferably from about 1.6:1 to 1.8:1. In this case, the polyurethane prepolymer thus contains terminal free isocyanate groups, because the polyisocyanate is used in excess, and the polyurethane polymer can be obtained from the polyurethane prepolymer by neutralization and dispersion in water, optionally followed by the further reaction with a capping agent such as water or a chain extender.

An important feature of the aqueous compositions of the present invention is that the compositions are crosslinkable and that during application or preferably after application of the composition to a substrate, a three-dimensional network can be formed by crosslinking the composition.

In the basic embodiment, the composition is rendered crosslinkable by incorporating reactive groups into the polyurethane polymer which are capable of reacting either with each other or with a crosslinking agent which preferably is also a compound of the aqueous coating composition.

In another embodiment, the polyurethane polymer is obtained from the reaction of a polyurethane prepolymer with a capping agent which contains an additional functionality which is susceptible to a thermal or radiation initiated crosslinking reaction. Hence, the dispersion may also optionally contain a thermal initiator or photo-initiator for radical or cationic polymerization.

In still another embodiment, the polyurethane does not contain a special functionality which is susceptible to a self-crosslinking reaction, but the aqueous coating composition contains a crosslinking agent which can react with the polyurethane polymer to form a three-dimensional molecule.

In the most preferred embodiment, the dispersion in water also contains a crosslinking agent which preferably is a reactive functionalized oligomer or polymer other than the polyurethane polymer.

The polyisocyanate (compound i) used according to the present invention for the preparation of the polyurethane prepolymer may be an aliphatic, cycloaliphatic, aromatic or heterocyclic polyisocyanate or a combination thereof. As example for suitable aliphatic diisocyanates there may be mentioned 1,4-diisocyanatobutane, 1,6-diisocyanatohexane, 1,6-diisocyanato-2,2,4-trimethylhexane, and 1,12-diisocyanatododecane either alone or in combination. Particularly suitable cycloaliphatic diisocyanates include 1,3- and 1,4-diisocyanatocyclohexane, 2,4-diisocyanato-1-methyl-cyclohexane, 1,3-diisocyanato-2-methylcyclohexane, 1-isocyanato-2-(isocyanatometyl)-cyclopentane, 1,1′-methylenbis[4-isocyanatocyclohexane], 1,1′-(1-methylethylidene)bis[4-isocyanato-cyclohexane], 5-isocyanato-1-isocyanatomethyl-1,3,3-trimethylcyclohexane (isophorone diisocyanate), 1,3- and 1,4-bis(isocyanatomethyl)cyclohexane, 1,1′-methylene-bis[4-isocyanato-3-methylcyclohexane], 1-isocyanato-4(or 3)-isocyanatomethyl-1-methylcyclohexane either alone or in combination. Particularly suitable aromatic diisocyanates comprise 1,4-diisocyanatobenzene, 1,1′-methylenebis[4-isocyanatobenzene], 2,4-diisocyanato-1-mthylethylidene)bis[4-isocyanatobenzene], 1,3- and 1,4-bis[1-isocyanato-1-methylethyl)benzene, 1,5-naphtalene diisocyanate, either alone or in combination. Aromatic polyisocyanates containing 3 or more isocyanate groups may also be used such as 1,1′,1″-methylidynetris[4-isocyanatobenzene] and polyphenyl polymethylene polyisocyanates obtained by phosgenation of aniline/formaldehyde condensates.

The total amount of the organic polyisocyanate is not particularly restricted, but generally is in the range from 10 to 60 wt % of the polyurethane polymer, preferably from 20 to 50 wt % and more preferably from 30 to 40 wt %.

In a preferred embodiment said polyisocyanate is selected from cycloaliphatic polyisocyanates, especially preferred is the use of methylene-bis(cyclohexyl isocyanate).

The organic compounds containing at least two reactive groups which can react with isocyanates (compound ii) are preferably polyols, but e.g. amines can also be used.

Suitable examples are polyester polyols, polyether polyols, polycarbonate polyols, polyacetal polyols, polyesteramide polyols, polyacrylate polyols, polythioether polyols and combinations thereof. Preferred are the polyester polyols, polyether polyols and polycarbonate polyols. These organic compounds containing at least two reactive groups which are enabled to react with isocyanates, preferably have a number average molecular weight within the range of 400 to 5,000, preferably 600 to 1,000.

Polyester polyols are particularly preferred and suitable polyester polyols which may be used comprise the hydroxyl-terminated reaction products of polyhydric, preferably dihydric alcohols (to which trihydric alcohols may be added) with polycarboxylic, preferably dicarboxylic acids or their corresponding carboxylic acid anhydrides.

Polyester polyols obtained by the ring opening polymerization of lactones may also be used. The polyester polyol may also contain an air-drying component such as a long chain (un)saturated fatty acid.

The polycarboxylic acids which may be used for the formation of these polyester polyols may be aliphatic, cycloaliphatic, aromatic and/or heterocyclic and they may be substituted (e.g. by halogen atoms) and saturated or unsaturated. As examples of aliphatic dicarboxylic acids, there may be mentioned, succinic acid, glutaric acid, adipic acid, suberic acid, azelaic acid, sebacic acid and dodecanedicarboxylic acid. As an example of a cycloaliphatic dicarboxylic acid, there may be mentioned hexahydrophthalic acid. Examples of aromatic dicarboxylic acids include isophthalic acid, terephthalic acid, ortho-phthalic acid, tetrachlorophthalic acids and 1,5-naphthalenedicarboxylic acid. Among the unsaturated aliphatic dicarboxylic acids which may be used, there may be mentioned fumaric acid, maleic acid, itaconic acid, citraconic acid, mesaconic acid and tetrahydrophthalic acid. Examples of tri- and tetracarboxylic acids include trimellitic acid, trimesic acid and pyromellitic acid.

The polyhydric alcohols which are preferably used for the preparation of the polyester polyols include ethylene glycol, propylene glycol, 1,3-propanediol, 1,3-butanediol, 1,4-butanediol, 1,5-pentanediol, 1,6-hexanediol, neopentyl glycol, diethylene glycol, dipropylene glycol, triethylene glycol, tetraethylene glycol, dibutylene glycol, 2-methyl-1,3-pentanediol, 2,2,4-trimethyl-1,3-pentanediol, 1,4-cyclohexanedimethanol, ethylene oxide adducts or propylene oxide adducts of bisphenol A or hydrogenated bisphenol A. Triols or tetraols such as trimethylolethane, trimethylolpropane, glycerin and pentaerythritol may also be used. These polyhydric alcohols are generally used to prepare the polyester polyols by polycondensation with the above-mentioned polycarboxylic acids, but according to a particular embodiment they can also be added as such to the polyurethane prepolymer reaction mixture.

In a preferred embodiment the polyester polyol is made from the polycondensation of neopentylglycol and adipic acid.

Suitable polyether polyols comprise polyethylene glycols, polypropylene glycols and polytetramethylene glycols, or bloc copolymers thereof.

Suitable polycarbonate polyols which may be used include the reaction products of diols such as 1,3-propanediol, 1,4-butanediol, 1,6-hexanediol, diethylene glycol, triethylene glycol or tetraethylene glycol with phosgene, with dialkylcarbonates or diarylcarbonates such as dimethylcarbonate or diphenylcarbonate or with cyclic carbonates such as ethylene and/or propylene carbonate.

Suitable polyacetal polyols which may be used include those prepared by reacting glycols such as diethyleneglycol with formaldehyde. Suitable polyacetals may also be prepared by polymerizing cyclic acetals.

The total amount of these organic compounds containing at least two reactive groups which can react with isocyanates preferably ranges from 30 to 90 wt % of the polyurethane polymer, more preferably of from 45 to 65 wt %.

The at least one compound which is capable to react with an isocyanate group and which contains at least one additional functional group (compound iii) usually is an alcohol or a polyol having at least one pendant functionality. Such an alcohol or polyol typically contains at least one water soluble side chain of ionic or non-ionic nature suitable to allow the polymer dispersion in water. Preferably, the polyol has at least one functional group such as anionic salt group or similar precursor which may be subsequently converted to such anionic salt group, such as carboxylic or sulfonic acid groups. It is also possible that the polyol comprises one or more other functional group which are susceptible to a crosslinking reaction, such as isocyanate, hydroxy, amine, acrylic, allylic, vinyl, alkenyl, alkinyl, halogen, epoxy, aziridine, aldehyde, ketone, anhydride, carbonate, silanol, acetoacetoxy, carbodiimide, ureidoalkyl, N-methylolamine, N-methylolamide N-alkoxy-methyl-amine, N-alkoxy-methyl-amide, or the like.

Compounds which are capable of reacting with isocyanate groups and conning at least one anionic salt group (or acid group which may be subsequently converted to such anionic salt group) preferably are the compounds containing the dispersing anionic group which are necessary to render the polyurethane prepolymer self dispersible in water e.g. sulfonate salt or carboxylate salt groups. According to the invention, these compounds are preferably used as reactants for the preparation of the isocyanate-terminated polyurethane prepolymer.

The carboxylate salt groups incorporated into the isocyanate-terminated polyurethane prepolymers generally are derived from polyhydroxycarboxylic acids represented by the general formula (HO)ₓR(COOH)_{y}, wherein R represents a straight or branched hydrocarbon residue having 1 to 12 carbon atoms, and x and y independently are integers from 1 to 3. Examples of these hydroxycarboxylic acids include citric acid and tartaric acid. The most preferred hydroxycarboxylic acids are the α,α-dimethylolalkanoic acids, wherein x=2 and y-1 in the above general formula, such as for example, the 2,2-dimethylolpropionic acid. The pendant anionic salt group content of the polyurethane polymer may vary within wide limits but should be sufficient to provide the polyurethane with the required degree of water-dispersability and crosslinkability (if no other crosslinkable group is incorporated in the polyurethane polymer which provides the required crosslinkability). Typically, the total amount of these anionic salt group-containing compounds in the polyurethane polymer can range from 1 to 25 wt % of the polyurethane polymer, preferably from 4 to 10 wt %.

The sulfonate salt groups can be introduced in this prepolymer using sulfonated polyesters obtained by the reaction of sulfonated dicarboxylic acids with one or more of the above-mentioned polyhydric alcohols, or by the reaction of sulfonated diols with one or more of the above-mentioned polycarboxylic acids. Suitable examples of sulfonated dicarboxylic acids include 5-(sodiosulfo)-isophthalic acid. Suitable examples of sulfonated diols include sodiosulfohydroquinone and 2-(sodiosulfo)-1,4-butanediol.

Any acid functionality which may be present in the polyurethane prepolymer can be converted to anionic salt groups by neutralization of said groups, before or simultaneously with the preparation of an aqueous dispersion of this prepolymer. The dispersion process of the polyurethane prepolymer is well known to those skilled in the art, and usually requires rapid mixing with a high shear rate type mixing head. Preferably, the warm or cold polyurethane prepolymer is added to the water under vigorous agitation or, alternatively, water may be stirred into the warm or cold polyurethane prepolymer.

Suitable neutralizing or quaternizing agents for converting the above mentioned acid groups of the polyurethane prepolymers into anionic salt groups during or before the dispersion in water can be volatile organic bases and/or non-volatile bases, especially triethylamine.

Suitable volatile organic bases can be preferably selected from the group comprising ammonia, trialkylamines such as trimethylamine, triethylamine, triisopropylamine, tributylamine and N,N-dimethylcyclohexylamine, N,N-dimethylaniline, N-methylmorpholine, N-methylpiperazine, N-methylpyrrolidine, N-methylpiperidine and their mixtures. The trialkylamines are preferred.

Suitable non-volatile bases include those comprising monovalent or bivalent metals, preferably alkali metals such as lithium, sodium, potassium or calcium. These nonvolatile bases may be used in the form of inorganic or organic salts, preferably inorganic salts wherein the anions do not remain in the dispersions such as metal hydroxides, carbonates and bicarbonates.

The total amount of these neutralizing agents should be stoechiometrically calculated according to the total amount of acid groups to be neutralized. To ensure that all acid groups are neutralized in the case volatile organic bases are used, it is advisable to add the neutralizing agent in an excess of 0 to 30 wt %, preferably 0 to 10 wt %.

The aqueous polyurethane polymer is prepared by dispersing the neutralized polyurethane polymer in water or alternatively the addition of water to the neutralized prepolymer solution, until phase inversion occurs and water becomes the dispersing phase.

If the functional groups are acidic groups which should be transformed to anionic groups, it can be preferable that the neutralizing reaction of the acidic groups is performed before the polyurethane prepolymer is dispersed into the aqueous medium. However, it is also possible that the aqueous medium into which the polyurethane polymer is dispersed contains the neutralizing agent.

Polyurethane prepolymer dispersions can be converted to high molecular weight polyurethane polymer dispersions after chain extension of the free isocyanate end groups with a capping agent (v), wherein the capping agent is a well known agent used to inactivate the terminal isocyanate groups. The capping agent can e.g. be water or a usual chain extender.

The chain extender should carry active hydrogen atoms which react with the terminal isocyanate groups of the polyurethane prepolymer. The chain extender is suitably a water-soluble aliphatic, alicyclic, aromatic or heterocyclic primary or secondary polyamine having up to 80, preferably up to 12 carbon atoms.

When the chain extension of the polyurethane prepolymer is effected with a polyamine, the total amount of polyamine should be calculated according to the stoechiometric amount of isocyanate groups present in the polyurethane prepolymer in order to obtain a fully reacted polyurethane polymer (a polyurethane urea) with no residual free isocyanate groups; the polyamine used in this case may have an average functionality of 2 to 4, preferably 2 to 3.

The degree of non-linearity of the polyurethane polymer is controlled by the functionality of the polyamine used for the chain extension. The desired functionality can be achieved by mixing polyamines with different amine functionalities. For example, a functionality of 2.5 may be achieved by using equimolar mixtures of diamines and triamines.

Examples of such chain extenders useful herein comprise hydrazine, ethylene diamine, piperazine, diethylene triamine, triethylene tetramine, tetraethylene pentamine, pentaethylene hexamine, N,N,N-tris(2-aminoethyl)amine, N-(2-piperazinoethyl)ethylenediamine, N,N′-bis(2-aminoethyl)piperazine, N,N,N′-tris(2-aminoethyl)ethylenediamine, N-[N-(2-aminoethyl)-2-aminoethyl]-N′-2-aminoethyl)piperazine, N-(2-aminoethyl)-N′-(2-piperazinoethyl)ethylenediamine, N,N-bis(2-aminoethyl)-N-(2-piperazinoethyl)amine, N,N-bis(2-piperazinoethyl)amine, guanidine, melamine, N-(2-aminoethyl)-1,3-propanediamine, 3,3′-diaminobenzidine 2,4,6-triaminopyrimidine, dipropylenetriamine, tetrapropylenepentamine, tripropylenetetramine, N,N-bis(6-aminohexyl)amine, N,N′-bis(3-aminopropyl)ethylene-diamine, 2,4-bis(4′-aminobenzyl)aniline, 1,4-butanediamine, 1,6-hexanediamine, 1,8-octanediamine, 1,10-decanediamine, 2-methylpentamethylenediamine, 1,12-dodecanediamine, isophorone diamine (or 1-amino3-aminomethyl-3,5,5-trimethyl-cyclohexane), bis(4-aminocyclohexyl)methane [or bis(aminocyclohexane-4-yl)-methane], and bis(4-amino-3-methylcyclohexyl)methane [or bis(amino-2-methylcyclohexane-4-yl)methane], alpha, omega-polypropyleneglycol-diamine-sulfopropylated sodium salts, polyethylene amines, polyoxyethylene amines and/or polyoxypropylene amines (e.g. Jeffamines from TEXACO).

In a preferred embodiment the chain extender is selected from aliphatic diamines, preferably it is 1,5-diamino-2-methyl-pentane.

The total amount of polyamines should be calculated according to the amount of isocyanate groups present in the polyurethane prepolymer. The ratio of isocyanate groups in the prepolymer to active hydrogen in the chain extender during the chain extension may be in the range of from about 1.0:0.7 to about 1.0:1.1, preferably from about 1.0:0.9 to about 1.0:1.02 on an equivalent basis.

The chain extension reaction is generally carried out at a temperature between 5° and 90° C., preferably between 10° to 50° C., and most preferably between 15° to 20° C.

In another embodiment of the present invention, the chain capping agent contains the reactive groups which are capable of effecting the crosslinking of the polyurethane polymer during or after application of the aqueous coating composition to the substrate. In this case, it is possible that the prepolymer is prepared by only three components and does not contain the at least one compound which is capable to react with an isocyanate group and which contains additional functional groups which are susceptible to a crosslinking reaction (compound iii), but, of course, such a compound may in addition also be used for preparing the prepolymer. Examples of these compounds are the gamma-aminopropyltrimethoxysilane, the gamma-aminopropyltriethoxysilane, the N-beta-aminoethyl-gamma-aminopropyltrimethoxysilane, the bis-(gamma-trimethoxysilylpropyl) amine, the N-beta-(aminoethyl)-gamma-aminopropylmethyldimethoxysilane, or the like.

In still another embodiment, the chain capping agent can be a poly(meth)acrylate compound capable to crosslink after thermal or radiation induced radical polymerisation.

In a further preferred embodiment of the present invention, sulfonates groups can be incorporated into the polyurethane polymer by a chain extension using sulfonated diamines as chain extenders, for example the sodium salt of 2,4-diamino-5-methylbenzenesulfonic acid or the sodium salt of sulfopropylated alpha, omega-polypropyleneglycol-diamine.

The aqueous coating composition of the present invention also contains at least one crosslinking agent. The term “crosslinking agent” as used in the present specification is not restrictive and encompasses all kinds of compounds which can react with the polyurethane polymer, preferably with functional groups of the polyurethane polymer to form a three-dimensional network. The aqueous coating composition of the present invention contains at least one crosslinking agent which is a vinyl-type polymer having functional groups reactive with the functional groups of the polyurethane polymer (A). These crosslinking agents have the additional benefit to (i) add additional features typically reserved for vinyl-type polymers, like an excellent aging (ii) participate to the decrease of the minimum film formation temperature without sacrifying the hardness of the polyurethane component or using high amounts of coalescing solvents (iii) offer an improved performance due to the self-crosslinking reaction without generating restrictions linked to a limited pot-life or to toxicity problems. The term “vinyl-type” polymer as used in the present specification is not specifically restricted and should encompass all types of polymers obtainable by polymerization, preferably by free radical addition polymerization of a vinyl-type monomer.

The vinyl-type polymer may be prepared by any suitably free-radical initiated polymerisation technique, preferably by emulsion polymerization or alternatively by miniemulsion polymerisation.

The vinyl-type polymers for use in the present invention may preferably have a weight average molecular weight within the range of 10,000 to 500,000, preferably between 100,000 and 500,000.

The emulsion polymerisation of the monomers may be carried out according to known methods, for example by using a semi-batch process wherein a pre-emulsion of the above-mentioned monomers is introduced into a reactor containing an aqueous solution of a free-radical initiator and heated at a constant temperature between 60° and 95° C., preferably between 75° and 85° C., for a period of 1 to 4, preferably 2 to 3 hours to complete the reaction.

The pre-emulsion of the monomers can be prepared by adding each monomer with stirring to an aqueous solution of an emulsifier, preferably an anionic type emulsifier, such as for example lauryl sulfate, dodecylbenzenesulfonate, dodecyl diphenyloxide disulfonate, alkylphenoxypoly(ethyleneoxy)- or (propyleneoxy)sulfates and combination thereof or dialkylsulfosuccinates, wherein the alkyl residue may have from 8 to 12 carbon atoms. Most preferably, a nonylphenoxypoly(ethyleneoxy)sulfate is used. It is to be understood that non-ionic emulsifiers may also be used.

Conventional free-radical initiators are used for the polymerisation of the monomers, such as for example hydrogen peroxide, tert-butylhydroperoxide, alkali metal persulfates or ammonium persulfate.

Vinyl-type monomers are generally ethylenically unsaturated, preferably monoethylenically unsaturated monomers. Preferred ethylenically unsaturated monomers which may be used for the formation of the vinyl-type polymer are selected from the group comprising

a) α,β-monoethylenically unsaturated carboxylic acid and their esters like alkyl acrylates and alkyl methacrylates, which have an alkyl residue of 1 to 12 carbon atoms, such as methyl methacrylate, methyl acrylate, ethyl acrylate, butyl acrylate, 2-ethylhexyl acrylate, isooctyl acrylate, nonyl acrylate and dodecyl acrylate,

b) α,β-monoethylenically unsaturated carboxylic acid and their functionalised esters like hydroxyalkyl acrylates and hydroxyalkyl methacrylates, which have an alkyl residue of 1 to 12 carbon atoms, such as hydroxyethyl acrylate, hydroxyethyl methacrylate,

c) vinyl substituted aromatic hydrocarbons such as styrene, α-methylstyrene and the like,

d) α,β-ethylenically unsaturated carbonamides such as acrylamide, methacrylamide, methoxymethylacrylamide, N-methylolacrylamide and the like,

e) vinyl esters of aliphatic acids such as vinyl acetate, vinyl versatate and the like (versatates are esters of tertiary monocarboxylic acids having C9, C10 and C11 chain length),

f) vinyl chloride and vinylidene chloride,

g) monoethylenically unsaturated sulfonates such as the alkali metal salts of styrenesulfonic acid, 2-acrylamido-2-methyl-propanesulfonic acid, 2-sulfoethyl methacrylate, 3-sulfopropyl methacrylate and the like (internal surfactants).

Necessarily, at least one of said monomers must contain a functional group reactive with the functional group of polyurethane polymer (A). Said monomers preferably have at least one functional group chosen between carboxylic and sulfonic acids, isocyanates, hydroxy, amine, acrylic, allylic, vinyl, alkenyl, alkyl, halogen, epoxy, aziridine, aldehyde, ketone, anhydride, carbonate, silane, acetoacetoxyalkyl, carbodiimide, ureidoalkyl, N-methylolamine, N-methylolamide N-alkoxy-methyl-amine, N-alkoxy-methyl-amide, or the like. Hence, the vinyl-type polymer contains functional groups which can bind to the crosslinkable reactive groups of the polyurethane polymer, so that crosslinking is achieved during or after application of the coating composition to the substrate. In particular, one of said monomers may be an α,β-monoethylenically unsaturated carboxylic acid, such as acrylic acid, methacrylic acid, itaconic acid beta-carboxyethyl(meth)acrylateor the like, and present in an amount of 0 to 30 wt % preferably 1 to 5% of the vinyl-type polymer.

It can be advantageous to use an emulsion polymerization process with a sequential monomer addition feed known to those skilled in the art in order to obtain core & shell or assimilated particle morphology that help the film formation process while giving at the same time an improved hardness and resistance of the coating.

In a preferred embodiment of the present invention, the aqueous coating composition contains a crosslinking agent which is a vinyl-type monomer as described above which contains as functional groups chain-pendant acetoacetoxyalkyl ester groups capable to react with the polyurethane polymer containing anionic salt groups, preferably carboxylate salt groups. Such vinyl-type polymers with chain-pendant acetoacetoxyalkyl ester groups can e.g. be prepared by polymerizing vinyl-type monomers as discussed above, wherein at least a part of the vinyl-type monomers contains an acetoacetoxyalkyl ester group. In a preferred embodiment, the vinyl-type monomers have the general formula R¹—O—CO—CH₂—CO—CH₃ wherein R¹ represents a CH₂═CR′—COO—R″-group or a CH₂═CR′R″-group in which R′ is —H or —CH₃, and R″ is an alkyl residue having 1 to 12 carbon atoms. The most preferred monomers of this type are acetoacetoxyethyl acrylate and acetoacetoxyethyl methacrylate.

The amount of the monoethylenically unsaturated monomer containing an acetoacetoxyalkyl ester group may generally vary from about 1 to about 80 wt %, preferably from about 5 to 50 wt % and most preferably 5 to 20 wt % of the vinyl polymer.

Thus, the preferred crosslinking agent is a vinyl-type polymer comprising chain-pendant acetoacetoxyalkyl ester functional groups, preferably formed by the free-radical addition polymerisation of at least one monoethylenically unsaturated monomer containing an acetoacetoxyalkyl ester group with at least one other ethylenically unsaturated monomer as defined above.

Vinyl-type polymers containing chain-pendant functional acetoacetoxyalkyl ester groups and methods for producing such polymers are e.g. disclosed in U.S. Pat. No. 5,541,251.

The vinyl-type polymer can be combined with the polyurethane polymer in an aqueous composition by dispersing both compounds in an aqueous medium, preferably water.

The composition according to the invention is preferably formed by homogenously mixing together at room temperature an aqueous dispersion of at least one polyurethane polymer and an aqueous dispersion of at least one vinyl polymer.

In another embodiment, the vinyl-type polymer is formed in situ by polymerizing one or preferentially several vinyl-type monomers in the presence of the polyurethane polymer, preferably in the presence of an aqueous polyurethane dispersion. Alternatively, it is also possible to prepare the polyurethane polymer in the presence of the vinyl-type polymer, by subjecting an isocyanate-terminated polyurethane prepolymer having anionic salt functional groups to chain-extension with a capping agent in the presence of the vinyl-type polymer having functional groups, preferably in the presence of an aqueous dispersion of the vinyl-type polymer.

Finally, it is possible to mix the polyurethane prepolymer with vinyl type monomers and to polymerise in the water phase or in solvent phase (and then to neutralise and disperse in water the intimate polymer mix into hybrid particles).

Thus, in the most preferred embodiment of the present invention, the polyurethane polymer contains additional functional groups which are susceptible to a crosslinking reaction and which are an anionic salt group, preferably a group COOM or SO3M, wherein M represents an alkali metal or a tetraalkylammonium or tetraalkylphosphonium group, as defined in U.S. Pat. No. 5,541,251 and the crosslinking agent is a vinyl-type polymer having chain-pendant acetoacetoxyalkyl ester functional groups, whereby crosslinking is effected at moderate temperatures during and/or after film-formation. These compositions have a remarkably long pot-life and do not require expensive and potentially toxic crosslinking agents.

In an embodiment of the present invention described above, the aqueous coating composition comprises the polyurethane polymer and the vinyl-type polymer in a weight ration of 95:5 to 5:95, preferably of 1:10 to 10:1, more preferably of 1:4 to 4:1 and most preferably of 1:2 to 2:1.

The aqueous coating composition of the present invention can comprise additional crosslinking agents, e.g. polyfunctional molecules having reactive functionalities including carboxylic and sulfonic acids, isocyanates, hydroxy, amine, acrylic, allylic, vinyl, alkenyl, alkinyl, halogen, epoxy, aziridine, aldehyde, ketone, anhydride, carbonate, silane, acetoacetoxy, carbodiimide, ureidoalkyl, N-methylolamine, N-methylolamide N-alkoxy-methyl-amine, N-alkoxy-methyl-amide, or the like. These other crosslinking agents may be present in the aqueous coating composition alone or in combination with one another or with the vinyl-type polymer as discussed above. Which crosslinking agent should be used depends on the type of crosslinkable functionality in the polyurethane polymer and the crosslinking agent can be chosen by a skilled person accordingly.

In a particular embodiment of the present invention, the aqeous coating composition additionally comprises at least one polyfunctional primary or secondary amine, preferably having a molecular weight of less than 1000, more preferably aliphatic amines such as ethylenediamine, hexamethylenediamine, isophoronediamine and diethylenetriamine and triethylenetetramine, adipic dihydrazine.

If desired, the compositions of the present invention may include other auxiliary substances (additives) which may be added to the final composition in order to impart or improve desirable properties or to suppress undesirable properties. These additives include biocides, antioxidants, plasticizers, colorants, pigments, silica sols and the known surfactants, leveling agents, wetting agents, humectants, antifoaming agents, foam control agents, thickening agents, coalescing agents, heat stabilizers, UV-light stabilizers, waxes, etc. The composition may also be blended with other polymer dispersions in water, for example polyvinyl acetate/versatate, epoxy resins, polyethylene, polypropylene, polystyrene, polybutadiene, polyvinyl chloride, polyvinylidene chloride, polyacrylate or other homopolymer and copolymer dispersions.

The crosslinking agent and optional auxiliary substances or additives can be included into the aqueous dispersion by stirring in a known manner.

The aqueous coating compositions suitably have a total solids content of from about 5 to 65 wt %, preferably from about 30 to 50 wt %, more preferably from 30 to 35 wt %; a viscosity measured at 25° C. of 10 to 5000 mPa s, preferably 100 to 500 mPa s, a pH value of 7 to 11, preferably of 7 to 9 and an average particle size of about 10 to 1000 nm, preferably 30 to 300 nm, more preferably 50 to 150 nm. The film formation temperature may preferably range from 0 to 25° C., more preferably from 0 to 5° C.

The polymer dispersions according to the invention exhibit a low film forming temperature associated with a very fast hardness development and a good resistance to water, solvents and stains.

The adhesive or protective aqueous coating composition of the invention can be easily applied to wood, which is the primary application for this invention, but also to any other substrate including not limitatively paper, cardboard, plastics, fabrics, glass, glass fibers, ceramics, concrete, leather, metals and the like, for industrial or domestic purposes and by any conventional method including brushing and roll coating, but also spraying, dipping, flexography and heliography, at room temperature or at elevated temperature.

The following examples are given for illustrating the invention.

The dry content was measured by a gravimetric method and expressed in %. The drying procedure requests 2 hours at 160° C.

The pH is measured using a conventional pH-meter fitted with a glass electrode.

The viscosity (η) of the aqueous polymer dispersions was measured at 25° C. with a Brookflield RVT Viscometer, using spindle No. 1 at 50 rpm when the viscosity was under 200 mPa s or spindle No. 2 at 50 rpm when the viscosity was higher than 200 mPa s, and is expressed in mPa·s

The average particle size of the aqueous polymer dispersions was measured by laser light scattering using a Malvern Particle Analyzer Processor types 7027 & 4600SM, and is expressed in run.

The grits value is the amount of residue from the polymer dispersion filtered on a 50μ sieve and is expressed in mg/liter.

The polymer blends are prepared under efficient agitation and formulated accordingly with UCECOAT XE 430 (thickener) in order to obtain a viscosity of about 1000 mPa·s and with a coalescing agent only when specified in the text.

Except when otherwise stated, the waterbased formulations are applied on wood using a brush: 3 consecutive uniform layers are prepared with a drying time of 1 hour between the layers always followed by a gentle rubbing with sand paper. After having been applied to the substrate, the 3-layered coatings are allowed to cure at ambient temperature (23°, 50% relative humidity) for a period of 7 days.

The König hardness is assessed according to DIN 53157 as follows: a 100μ (wet) coating is applied on a glass plate using a Meyer bar. The film is placed in a conditioned room (23° C., 50% humidity) and is allowed to dry. A measurement of the hardness is made after 1 hour, 4 hours, 1 day, 4 days, 7 days using a König pendulum equipment. The pendulum records the oscillation time in seconds (s) between two fixed angles. High oscillation values correspond to high coatings hardness.

The Minimal Film Formation Temperature (MFFT) is assessed as follows: a wet coating is applied on a stainless steel plate with a stable temperature gradient and covered with a top cover to prevent air circulation. The film is allowed to dry, and the minimum temperature delivering a uniform and scratch resistant coating is recorded.

The quality of the film is assessed as follows: a coating is made on wood using a brush and allowed to dry at 23° C. and 50% humidity. After 24 hours, the coating is dry and the quality of the film formation is observed using a microscope in order to detect micro-crack defects. The same test can be performed at 5° C. A quotation is given on a 1-5 scale (5=no defects).

The clarity is assessed as follows: a 100μ (wet) coating is applied on a black reference substrate (Leneta) and on a glass plate using a Meyer bar. The film is placed in a conditioned room (23° C., 50% humidity) and is allowed to dry. A visual assessment of the film haze and/or whiteness (on Leneta) and the film transparency (on glass) is made and a quotation is given on a 1-5 scale (1=white, hazy 5=transparent). A high clarity is expected to provide coatings with an excellent and decorative aspect.

The stain resistance of a coating is assessed by putting a test substance covered with a microscope glass on the coating and left for 4 hours (1 hour for hot water). The test substances used are cold and hot water, mustard, ammonia, ethanol and red wine. The stains are washed after a couple of rubs using a tissue saturated with isopropanol. The remaining stains are assessed visually using a 1-5 scale, 5=best. A high value (5) is expected to provide the best protection against any household product spillage.

The solvent resistance is assessed by double rubs made by pressing the coating with a peace of cotton rag saturated with water ethanol 1:1 or with acetone while applying a forward and backward motion. The reported number is the number of double rubs required to break through the coating. A high value (>100) is expected for an optimum resistance.

The scratch resistance of the coatings is assessed using a coin which is firmly pressed and moved over the coating. The result of the damage observed is referred to a 1-5 scale, 5=best. A high scratch resistance is necessary to impart long term mechanical protection to the substrate

The adhesion was measured using an adhesive tape firmly pressed on a cross-cutted coating area and removed rapidly; the same wet test can be made when a drop of water is in contact with the cross-cutted coating area for 2 hours. The damage to the coating due to adhesion loss is expressed in a 1-5 scale, 5=best. A high adhesion (5) is necessary to ensure a strong permanent bond between the coating and the substrate.

The isocyanate content in a polyurethane prepolymer reaction mixture was measured using the dibutylamine back-titration method, and is expressed in meq/g.

In examples 1-3, only the process and solvent usage are modified (i.e. the polyurethane polymer composition remains unchanged) In examples 4-8, the composition of the polymers is being varied.

Comparative example. Reference synthesis of PU 1 with standard process using NMP.

A double-wall glass reactor equipped with a mechanical stirrer, a thermocouple, a vapor condenser and a dropping funnel was charged with 216.2 g of N-methylpyrrolidone, 141.5 g of a polyester diol having an average molecular weight ˜670 Daltons and obtained by the polycondensation of adipic acid and neopentylglycol, 42.6 g of cyclohexane dimethanol, 41.0 g of dimethylol propionic acid, 383.9 g of methylene bis(cyclohexyl isocyanate) and 0.8 g of dibutyltinlaurate solution in acetone (at 10% concentration) as reaction catalyst. The reaction mixture was heated up to 90° C. with stirring, and the condensation process was maintained until the isocyanate content reached 1.58 meq/g. The polyurethane prepolymer was cooled down to 70° C., and 30.3 g of triethylamine were added as neutralizing agent until a homogenous solution occurred.

The prepolymer solution was transferred over 5 minutes to a dispersion vessel equipped with a high shear cowless-type agitator and containing 1265.2 g of water (at 30° C.) and 0.2 g of Dehydran 1293 (anti-foam). The dispersion of the polymer was complete after about 10 minutes of stirring, and the resulting product was cooled down below 20° C. 68.1 g of 2-methyl-pentanediamine dissolved in 68.1 g of water were slowly added under efficient agitation to complete the chain extension and left for 3 hours more. The aqueous dispersion of a fully reacted polyurethane-urea was filtered an a 100μ sieve to deliver a stable polyurethane dispersion with a dry content of about 30.0%, a viscosity of 100 mPa·s, a pH of about 8.0, a particle size of about 50 nm and a grits content below 100 mg/l.

Comparative example. Reference synthesis of PU 2 with standard process using acetone.

A double-wall glass reactor equipped with a mechanical stirrer, a thermocouple, a vapor condenser and a dropping funnel was charged with 216.2 g of acetone, 141.5 g of a polyester diol having an average molecular weight ˜670 Daltons and obtained by the polycondensation of adipic acid and neopentylglycol, 42.6 g of cyclohexane dimethanol, 41.0 g of dimethylol propionic acid, 383.9 g of methylene bis(cyclohexyl isocyanate) and 0.8 g of dibutyltinlaurate solution in acetone (at 10% concentration) as reaction catalyst. The reaction mixture was heated up to the boiling point of the solvent (56° C.) with stirring, and the condensation process was maintained until the isocyanate content reached 1.58 meq/g. Then, the prepolymer solution is cooled down to 50° C., and 30.3 g of triethylamine were added as neutralizing agent until a homogenous solution occurred.

The prepolymer solution was transferred over 5 minutes to a dispersion vessel equipped with a high shear cowless-type agitator and containing 1265.2 g of water (at 30° C.) and 0.2 g of Dehydran 1293 (anti-foam). The dispersion of the polymer was complete after about 10 minutes of stirring, and the resulting product was cooled down below 20° C. 68.1 g of 2-methyl-pentanediamine dissolved in 68.1 g of water were slowly added under efficient agitation to complete the chain extension and left for 3 hour more. The polyurethane dispersion was transferred to the stripping vessel, then warmed up to 50° C. and the acetone was stripped out under vacuum and agitation until the free acetone level reaches a value below 0.15%. After about 1 hour of a gentle agitation, the aqueous dispersion of a fully reacted polyurethane-urea were filtered on a 100μ sieve to deliver a stable polyurethane dispersion with a dry content of about 30.0%, a viscosity of 100 mPa·s, a pH of about 8, a particle size of about 50 nm and a grits content below 100 mg/l.

Example Reference synthesis of PU 3 with novel “coalescent-in-synthesis” process using Dowanol PGDA.

A double-wall glass reactor equipped with a mechanical stirrer, a thermocouple, a vapor condenser and a dropping funnel was charged with 91.0 g of Dowanol PGDA, 141.5 g of a polyester diol having an average molecular weight ˜670 Daltons and obtained by the polycondensation of adipic acid and neopentylglycol, 42.6 g of cyclohexane dimethanol, 41.0 g of dimethylol propionic acid, 383.9 g of methylene bis(cyclohexyl isocyanate) and 0.7 g of dibutyltinlaurate solution in acetone (at 10% concentration) as reaction catalyst. The reaction mixture was heated up to 90° C. with stirring, and the condensation process was maintained until the isocyanate content reached 1.86 meq/g. The polyurethane prepolymer was cooled down to 70° C., and 30.3 g of triethylamine were added as neutralizing agent until a homogenous solution occurred. 1390.3 g of water (at 30° C.) and 0.2 g of Dehydran 1293 (anti-foam) were added under vigorous agitation to the polymer solution beyond the phase inversion point. After about 10 minutes of stirring, the dispersion of the polymer was complete and the resulting product was cooled below 20° C. 68.1 g of 2-methyl-pentanediamine dissolved in 68.1 g of water were slowly added under efficient agitation to complete the chain extension and left for 1 hour more. After about 3 hour of a gentle agitation, the aqueous dispersion of a fully reacted polyurethane-urea were filtered an a 100% sieve to deliver a stable polyurethane dispersion with a dry content of about 30%, a viscosity of about 100 mPa·s, a pH of about 8, a particle size of about 100 nm and a grits content below 100 mg/l.

Example. In this synthesis of PU 4 with the novel “coalescent-in-synthesis” process, there is a variation of the coalescing solvent (Proglyde DMM) and the chain extender (m-xylylenediamine).

A double-wall glass reactor equipped with a mechanical stirrer, a thermocouple, a vapor condenser and a dropping funnel was charged with 104 g of Proglyde DMM, 161.7 g of a polyester diol having an average molecular weight ˜670 Daltons and obtained by the polycondensation of adipic acid and neopentylglycol, 48.6 g of cyclohexane dimethanol, 46.9 g of dimethylol propionic acid, 438.8 g of methylene bis(cyclohexyl isocyanate) and 0.8 g of dibutyltinlaurate solution in acetone (at 10% concentration) as reaction catalyst. The reaction mixture was heated up to 90° C. with stirring, and the polycondensation process was maintained until the isocyanate content reached 1.86 meq/g. The polyurethane prepolymer was cooled down to 70° C., and 35.0 g of triethylamine were added as neutralizing agent until a homogenous solution occurred. 1402.9 g of water (at 30° C.) and 0.8 g of Dehydran 1293 (anti-foam) were added under vigorous agitation to the polymer solution beyond the phase inversion point. After about 5 minutes of stirring, the dispersion of the polymer was complete and the resulting product was cooled below 20° C. 100.7 g of m-xylylenediamine dissolved in 302.2 g of water were slowly added under efficient agitation to complete the chain extension and left for 3 hours of a gentle agitation. The aqueous dispersion of a fully reacted polyurethane-urea was filtered on a 200μ sieve to deliver a stable polyurethane dispersion with a dry content ca 30%, a viscosity ca 100 mPa·s, a pH ca 8, a particle size ca 100 nm and a grits content below 100 mg/l.

Example. In this synthesis of PU 5 with the novel “coalescent-in-synthesis” process, there is a reduction of the isocyanate/hydroxyl ratio (1.6) implying and increased prepolymer molecular weight and a reduced urethane weight contents.

A double-wall glass reactor equipped with a mechanical stirrer, a thermocouple, a vapor condenser and a dropping funnel was charged with 91 g of Proglyde DMM, 258.4 g of a polyester diol having an average molecular weight ˜670 Daltons and obtained by the polycondensation of adipic acid and neopentylglycol, 41.4 g of dimethylol propionic acid, 309.2 g of methylene bis(cyclohexyl isocyanate) and 0.7 g of dibutyltinlaurate solution in acetone (at 10% concentration) as reaction catalyst. The reaction mixture was heated up to 90° C. with stirring, and the polycondensation process was maintained until the isocyanate content reached 1.39 meq/g. The polyurethane prepolymer was cooled down to 70° C., and 30.6 g of triethylamine were added as neutralizing agent until a homogenous solution occurred. 1236.6 g of water (at 30° C.) and 0.7 g of Dehydran 1293 (anti-foam) were added under vigorous agitation to the polymer solution beyond the phase inversion point. After about 5 minutes of stirring, the dispersion of the polymer was complete and the resulting product was cooled below 20° C. 59.6 g of m-xylylenediamine dissolved in 178.6 g of water were slowly added under efficient agitation to complete the chain extension and left for 3 hours of a gentle agitation. The aqueous dispersion of a fully reacted polyurethane-urea was filtered on a 200μ sieve to deliver a stable polyurethane dispersion with a dry content ca 30%, a viscosity ca 100 mPa·s, a pH ca 8, a particle size ca 100 nm and a grits content below 100 mg/l.

Example. In this synthesis of PU 6 with the novel “coalescent-in-synthesis” process, here is a stoechiometric replacement of the dimethylol propionic acid (DMPA) by the dimethylol butanoic acid (DMBA).

A double-wall glass reactor equipped with a mechanical stirrer, a thermocouple, a vapor condenser and a dropping funnel was charged with 91 g of Proglyde DMM, 256.6 g of a polyester diol having an average molecular weight ˜670 Daltons and obtained by the polycondensation of adipic acid and neopentylglycol, 45.4 g of dimethylol propionic acid, 307.0 g of methylene bis(cyclohexyl isocyanate) and 0.7 g of dibutyltinlaurate solution in acetone (at 10% concentration) as reaction catalyst. The reaction mixture was heated up to 90° C. with stirring, and the polycondensation process was maintained until the isocyanate content reached 1.38 meq/g. The polyurethane prepolymer was cooled down to 70° C., and 30.6 g of triethylamine were added as neutralizing agent until a homogenous solution occurred. 1245.1 g of water (at 30° C.) and 0.7 g of Dehydran 1293 (anti-foam) were added under vigorous agitation to the polymer solution beyond the phase inversion point. After about 5 minutes of stirring, the dispersion of the polymer was complete and the resulting product was cooled below 20° C. 56.7 g of m-xylylenediamine dissolved in 170.2 g of water were slowly added under efficient agitation to complete the chain extension and left for 3 hours of a gentle agitation. The aqueous dispersion of a fully reacted polyurethane-urea was filtered on a 200μ sieve to deliver a stable polyurethane dispersion with a dry content ca 30%, a viscosity ca 100 mPa·s, a pH ca 8, a particle size ca 100 nm and a grits content below 100 mg/l.

Example. In this synthesis of PU 7 with the novel “coalescent-in-synthesis” process, there is an addition of trimethylolpropane (TMP) resulting in a branched prepolymer.

A double-wall glass reactor equipped with a mechanical stirrer, a thermocouple, a vapor condenser and a dropping funnel was charged with 91 g of Proglyde DMM, 228.0 g of a polyester diol having an average molecular weight ˜670 Daltons and obtained by the polycondensation of adipic acid and neopentylglycol, 44.6 g of dimethylol propionic acid, 6.1 g of trimethylolpropane, 330.3 g of methylene bis(cyclohexyl isocyanate) and 0.7 g of dibutyltinlaurate solution in acetone (at 10% concentration) as reaction catalyst. The reaction mixture was heated up to 90° C. with stirring, and the polycondensation process was maintained until the isocyanate content reached 1.47 meq/g. The polyurethane prepolymer was cooled down to 70° C., and 33.6 g of triethylamine were added as neutralizing agent until a homogenous solution occurred. 1252.8 g of water (at 30° C.) and 0.7 g of Dehydran 1293 (anti-foam) were added under vigorous agitation to the polymer solution beyond the phase inversion point. After about 5 minutes of stirring, the dispersion of the polymer was complete and the resulting product was cooled below 20° C. 64.2 g of m-xylylenediamine dissolved in 192.5 g of water were slowly added under efficient agitation to complete the chain extension and left for 3 hours of a gentle agitation. The aqueous dispersion of a fully reacted polyurethane-urea was filtered on a 200μ sieve to deliver a stable polyurethane dispersion with a dry content ca 30%, a viscosity ca 100 mPa·s, a pH ca 8, a particle size ca 100 nm and a grits content below 100 mg/l.

Example. In this synthesis of PU 8 with the novel “coalescent-in-synthesis” process, there is a neutralization of the polymer with caustic soda instead of triethylamine (TEA).

A double-wall glass reactor equipped with a mechanical stirrer, a thermocouple, a vapor condenser and a dropping funnel was charged with 91 g of Proglyde DMM, 258.4 g of a polyester diol having an average molecular weight ˜670 Daltons and obtained by the polycondensation of adipic acid and neopentylglycol, 41.4 g of dimethylol propionic acid, 309.2 g of methylene bis(cyclohexyl isocyanate) and 0.7 g of dibutyltinlaurate solution in acetone (at 10% concentration) as reaction catalyst. The reaction mixture was heated up to 90° C. with stirring, and the polycondensation process was maintained until the isocyanate content reached 1.39 meq/g. The polyurethane prepolymer was cooled down to 70° C. 12.2 g of sodium hydroxide dissolved in 420.0 g of water (at 30° C.) was added as neutralizing agent until a homogenous solution occurred. The remaining 840.0 g of water (at 30° C.) and 0.7 g of Dehydran 1293 (anti-foam) were added under vigorous agitation to the reactor beyond the phase inversion point. After about 5 minutes of stirring, the dispersion of the polymer was complete and the resulting product was cooled below 20° C. 58.8 g of m-xylylenediamine dissolved in 176.4 g of water were slowly added under efficient agitation to complete the chain extension and left for 3 hours of a gentle agitation. The aqueous dispersion of a fully reacted polyurethane-urea was filtered on a 200μ sieve to deliver a stable polyurethane dispersion with a dry content ca 30%, a viscosity ca 100 mPa·s, a pH ca 8, a particle size ca 100 nm and a grits content below 100 mg/l.

Comparative example. Reference synthesis of ACRYL 1 using standard process without AAEM.

28.6 g of an aqueous solution of sodium nonylphenylpoly(oxyethylene)sulfate with n=10 (solids content of 34 wt %) and 28.6 g of an aqueous solution of nonylphenoxypoly(oxyethylene) with n=30 (solids content of 70 wt %) and 5.0 g of the potassium salt of 3-sulfopropyl methacrylate were introduced with stirring in a tank containing 290.0 g of demineralized water. Then, 575.0 g of methyl methacrylate, 410.0 g of 2-ethylhexyl acrylate and 15.0 g of acrylic acid were added thereto with strong stirring, and resulting in the formation of a preemulsion. 2.4 g of ammonium persulfate were added with stirring to a reactor containing 4.3 g of the above-mentioned aqueous solution of nonylphenylpoly(oxyethylene)sulfate in 720.0 g of demineralized water and heated up to 80° C. The pre-emulsion prepared above was then added into the resulting mixture over a period of 2.5 hours. The reactor was maintained at 80° C. for 2 hours to complete the reaction and then allowed to cool to room temperature. 10.0 g of a 25% (w/w) aqueous solution of ammonia were added slowly thereto. The resulting latex had a dry content of 48.0%, a viscosity of 315 mPa s, a pH of 8.5, an average particle size of 134 nm, a free monomer content of below 0.01 wt %, a grits content below 50 mg/l and a minimal film forming temperature of about 17° C. This vinyl polymer had no acetoacetoxyalkyl ester functional groups.

Example. Reference synthesis of ACRYL 2 using standard process with AAEM.

28.6 g of an aqueous solution of sodium nonylphenylpoly(oxyethylene)sulfate with n=10 (solids content of 34 wt %) and 28.6 g of an aqueous solution of nonylphenoxypoly(oxyethylene) with n=30 (solids content of 70 wt %) and 5.0 g of the potassium salt of 3-sulfopropyl methacrylate were introduced with stirring in a tank containing 290.0 g of demineralized water. Then, 550.0 g of methyl methacrylate, 385.0 g of 2-ethylhexyl acrylate, 50.0 g of acetoacetoxyethyl methacrylate and 15.0 g of acrylic acid were added thereto with strong stirring, and resulting in the formation of a preemulsion. 2.4 g of ammonium persulfate were added with stirring to a reactor containing 4.3 g of the above-mentioned aqueous solution of nonylphenylpoly(oxyethylene)sulfate in 720.0 g of demineralized water and heated up to 80° C. The pre-emulsion prepared above was then added into the resulting mixture over a period of 2.5 hours. The reactor was maintained at 80° C. for 2 hours to complete the reaction and then allowed to cool to room temperature. 10.0 g of a 25% (w/w) aqueous solution of ammonia were added slowly thereto. The resulting latex had a dry content of 48.6%, a viscosity of 232 mPa s, a pH of 6.0, an average particle size of 133 nm, a free monomer content of below 0.01 wt % (controlled by gas chromatography), a grits content below 50 mg/l and a minimal film forming temperature of about 20° C.

Example. Synthesis of ACRYL 3 using core & shell process with AAEM.

51.3 g of an aqueous solution of sodium nonylphenylpoly(oxyethylene)sulfate with n=10 (solids content of 30 wt %) and 14.8 g of an aqueous solution of nonylphenoxypoly(oxyethylene) with n=30 (solids content of 80 wt %) were introduced with stirring in the reactor containing 2073.8 g of demineralized water. 444.6 g of a seed latex made from the radical polymerisation of methyl methacrylate (3), styrene (54.2), butyl acrylate (23.6), 2-ethylhexylacrylate (17.7) and methacrilic acid and having a dry content of 37%, a pH of 7.5 and an almost homodisperse particle size of 57 nm. The temperature is raised to 80° C. and 2.3 g of sodium persulfate Is added to the reactor. A mixture of 1062.3 g of styrene and 38.5 g of 2-ethylhexyl acrylate is added during 1 h30′ with a parallel addition of 3.4 g of sodium persulfate dissolved in 72.7 g of water. The reaction mixture is allowed to react for a further 30′ under agitation. Then, a mixture of 71.9 g of 2-ethylhexyl acrylate, 575.6 g of butyl acrylate, 43.2 g of methacrylic acid and 43.2 g of acetoacetoxyethyl methacrylate were added to the reactor in a period of 1 h. The reactor was maintained at 80° C. for 1 hour to complete the reaction and then allowed to cool to room temperature. 25.0 g of a 25% (w/w) aqueous solution of ammonia were added slowly to neutralize the latex. The resulting product had a dry content of 44.6%, a viscosity of 100 mPa s, a pH of 7.0, an average particle size of 110 nm, a free monomer content of below 0.01 wt % (controlled by gas chromatography), a grits content below 50 mg/l and a minimal film forming temperature below 5° C.

Example. Synthesis of ACRYL 4 with a standard modified process and with a decrease of the glass transition temperature (Tg) by the reduction of the methyl methacrylate/2-ethylhexyl acrylate ratio; the acetoacetoxy- and carboxylic acid functionality is maintained.

38.3 g of an aqueous solution of dodecyl oxydibenzene disulfonate, sodium salt (solids content of 45 wt %) is introduced with stirring in a tank containing 361 g of demineralized water. Then, 517.5 g of methyl methacrylate, 557.8 g of 2-ethylhexyl acrylate, 57.5 g of acetoacetoxyethyl methacrylate and 17.3 g of acrylic acid were added consecutively with a strong agitation to form a stable monomer pre-emulsion. A reactor is charged with 828 g of demineralized water and 3.8 g of an aqueous solution of dodecyl oxydibenzene disulfonate, sodium salt (solids content of 45 wt %) under an efficient agitation. The reaction vessel is heated up to 80° C. and 2.9 g of potassium persulfate is added as the initiator. The pre-emulsion prepared above is then loaded into the reactor over a period of 2 hours, and the reactor is maintained at 80° C. for 2 hours to complete the reaction. The reactor then allowed to cool to room temperature and 3.8 g of a 25% (w/w) aqueous solution of ammonia is slowly added for neutralization. The resulting latex had a dry content of 49%, a viscosity ca 200 mPa·s, a pH ca 6.0, an average particle size ca 130 nm, a free monomer content of below 0.01 wt % (controlled by gas chromatography), a grits content below 50 mg/l and a minimal film forming temperature below 5° C.

Example. Synthesis of ACRYL 5 with a standard modified process and with a neutralization of the polymer with caustic soda instead of ammonia.

76.7 g of an aqueous solution of dodecyl oxydibenzene disulfonate, sodium salt (solids content of 45 wt %) is introduced with stirring in a tank containing 693 g of demineralized water. Then, 1265.0 g of methyl methacrylate, 885.5 g of 2-ethylhexyl acrylate, 115.0 g of acetoacetoxyethyl methacrylate and 34.5 g of acrylic acid were added consecutively with a strong agitation to form a stable monomer pre-emulsion. A reactor is charged with 1656 g of demineralized water and 7.7 g of an aqueous solution of dodecyl oxydibenzene disulfonate, sodium salt (solids content of 45 wt %) under an efficient agitation. The reaction vessel is heated up to 80° C. and 5.5 g of potassium persulfate is added as the initiator. The pre-emulsion prepared above is then loaded into the reactor over a period of 2.5 hours, and the reactor is maintained at 80° C. for 2 hours to complete the reaction. The reactor then allowed to cool to room temperature and 115 g of a 5% (w/w) aqueous solution of sodium hydroxide is slowly added for neutralization. The resulting latex had a dry content of 48%, a viscosity ca 200 mPa·s, a pH ca 6.0, an average particle size ca 130 nm, a free monomer content of below 0.01 wt % (controlled by gas chromatography), a grits content below 50 mg/l and a minimal film forming temperature ca 20° C.

### EXAMPLES 1 to 6

The polyurethane dispersions (PU 1-3) have been assessed alone as references 1-5 and combined with acrylic latexes in blends 1-6 as outlined in the table 1, 2 and according to the procedure described above.

TABLE 1
polyurethane references (PU 1-3)

| | | | COALESCENT |
|---|---|---|---|
| | POLYURETHANE | ACRYLIC | ADDED after |
| | POLYMER | POLYMER | synthesis |
| Reference 1 | PU 1 | — | — |
| | (NMP) | | |
| Reference 2 | PU 2 | — | — |
| | (ACETONE) | | |
| Reference 3 | PU 2 | — | 8% Dowanol |
| | (ACETONE) | | EB/DPM 1:3 |
| Reference 4 | PU 3 | — | — |
| | (PGDA coalescent) | | |
| Reference 5 | PU 3 | — | 8% Dowanol |
| | (PGDA coalescent) | | EB/DPM 1:3 |

TABLE 2
polyurethane:acrylic hybrid compositions from PU 1-3

| | | | COALESCENT |
|---|---|---|---|
| (50:50 dry | POLYURETHANE | ACRYLIC | ADDED after |
| blend) | POLYMER | POLYMER | synthesis |
| Blend 1 | PU 1 | ACRYL 1 | — |
| | (NMP) | (NO AAEM) | |
| Blend 2 | PU 1 | ACRYL 2 | — |
| | (NMP) | (AAEM) | |
| Blend 3 | PU 1 | ACRYL 3 | — |
| | (NMP) | (AAEM, C&S) | |
| Blend 4 | PU 2 | ACRYL 2 | — |
| | (ACETONE) | (AAEM) | |
| Blend 5 | PU 2 | ACRYL 2 | 4% Dowanol PGDA |
| | (ACETONE) | (AAEM) | |
| Blend 6 | PU 3 | ACRYL 2 | — |
| | (PGDA coalescent) | (AAEM) | |

The different polyurethane dispersions were applied on glass and assessed for König hardness as disclosed in table 3.

TABLE 3
König kinetics of drying from PU 1-3

| | Ratio % | | | | | |
|---|---|---|---|---|---|---|
| | 1 h/7 d | 1 h | 4 h | 24 h | 4 days | 7 days |
| Reference 1 | 6 | 10 | 22 | 69 | 138 | 151 |
| Mfft 15° C. | | | | | | |
| Reference 2 | NO FILM FORMATION AT ROOM TEMPERATURE | | | | | |
| Mfft > 70° C. | | | | | | |
| Reference 3 | 41 | 52 | 61 | 87 | 140 | 127 |
| Reference 4 | NO FILM FORMATION AT ROOM TEMPERATURE | | | | | |
| Mfft 63° C. | | | | | | |
| Reference 5 | 90 | 94 | 90 | 93 | 98 | 105 |

The different blends were applied on the several test substrates and assessed for performance as disclosed in tables 4 and 5.

TABLE 4
König kinetics of drying from PU 1-3

| | Ratio % | | | | | |
|---|---|---|---|---|---|---|
| | 1 h/7 d | 1 h | 4 h | 24 h | 4 days | 7 days |
| Blend 1 | 16 | 15 | 25 | 51 | 77 | 92 |
| (Mfft: 6° C.) | | | | | | |
| Blend 2 | 15 | 13 | 22 | 52 | 66 | 84 |
| (Mfft: 6° C.) | | | | | | |
| Blend 3 | 8 | 10 | 36 | 91 | 121 | 133 |
| (Mfft: 7° C.) | | | | | | |
| Blend 4 | 49 | 36 | 43 | 54 | 69 | 74 |
| (Mfft: 30°) | | | | | | |
| Blend 5 | 61 | 46 | 51 | 59 | 70 | 75 |
| (Mfft: 0° C.) | | | | | | |
| Blend 6 | 95 | 104 | 99 | 105 | 107 | 109 |
| (Mfft: 18°) | | | | | | |

TABLE 5
Properties & performance on wood for coatings from PU 1-3

| | | Stain | Ethanol | Scratch | Adhesion |
|---|---|---|---|---|---|
| | Clarity | resistance | resistance | resistance | dry-wet |
| | (1-5, best) | (1-5, best) | (d.rubs) | (1-5, best) | (1-5, best) |
| Blend 1 | 4 | 3.7 | 20 | 5? | 4-4 |
| Blend 2 | 4 | 4.3 | >100 | 5 | 4-5 |
| Blend 3 | 2 | 1.8 | >100 | 4 | 5-5 |
| Blend 4 | 4 | 3.5 | >100 | 2 | 4-3 |
| Blend 5 | 4 | 4.0 | >100 | 5 | 4-5 |
| Blend 6 | 3.5 | 4.0 | >100 | 5 | 4-5 |

### EXAMPLES 7 to 12

The polymer dispersions have been combined in examples 7-12 as outlined in the table 4 and according to the procedure described above. They further exemplify the scope of the invention.

TABLE 6
polyurethane:acrylic hybrid compositions from PU 4-8

| | | | COALESCENT |
|---|---|---|---|
| (50:50 dry | POLYURETHANE | ACRYLIC | ADDED after |
| blend) | POLYMER | POLYMER | synthesis |
| Blend 7 | PU 4 | ACRYL 2 | 4% Dowanol |
| | (Proglyde DMM | | EB/DPM |
| | coalescent) | | |
| Blend 8 | PU 5 | ACRYL 2 | 1% Proglyde DMM |
| | (Proglyde DMM | | |
| | coalescent) | | |
| Blend 9 | PU 6 | ACRYL 2 | 1% Proglyde DMM |
| | (Proglyde DMM | | |
| | coalescent) | | |
| Blend 10 | PU 7 | ACRYL 2 | 1% Proglyde DMM |
| | (Proglyde DMM | | |
| | coalescent) | | |
| Blend 11 | PU 8 | ACRYL 5 | 1% Proglyde DMM |
| | (Proglyde DMM | | |
| | coalescent) | | |
| Blend 12 | PU 5 | ACRYL 4 | — |
| | (Proglyde DMM | | |
| | coalescent) | | |

The different blends were applied on the test substrates and assessed for performance as disclosed in tables 5 and 6.

TABLE 7
König kinetics of drying from PU 4-8

| | Ratio % | | | | | |
|---|---|---|---|---|---|---|
| | 1 h/7 d | 1 h | 4 h | 24 h | 4 days | 7 days |
| Blend 7 | 85 | 90 | 94 | 97 | 101 | 106 |
| (Mfft: 17° C.) | | | | | | |
| Blend 8 | 69 | 59 | 66 | 66 | 84 | 86 |
| (Mfft: 9° C.) | | | | | | |
| Blend 9 | 68 | 61 | 64 | 71 | 75 | 90 |
| (Mfft: 2° C.) | | | | | | |
| Blend 10 | 75 | 75 | 78 | 84 | 88 | 100 |
| (Mfft: 8°) | | | | | | |
| Blend 11 | 78 | 87 | 88 | 100 | — | 112 |
| (Mfft: 8° C.) | | | | | | |
| Blend 12 | 64 | 39 | 44 | 52 | 61 | 61 |
| (Mfft: 0° C.) | | | | | | |

TABLE 8
Properties & performance on wood for coatings from PU 4-8

| | | Stain | Acetone | Scratch | Adhesion | RT film |
|---|---|---|---|---|---|---|
| | Clarity | resistance | resistance | resistance | dry-wet | formation |
| | (1-5, best) | (1-5, best) | (d.rubs) | (1-5, best) | (1-5, best) | (1-5, best) |
| Blend 7 | 2.25 | 3.5 | 85 | 4 | 1-1.5 | 4.5 |
| Blend 8 | 3.75 | 3.8 | 50 | 4 | 5-5 | 4.5 |
| Blend 9 | 3.75 | 3.58 | 60 | 2 | 4-5 | 4 |
| Blend 10 | 3.5 | 4.25 | 90 | 3 | 3.5-4.5 | 3.5 |
| Blend 11 | 4.0 | 3.35 | 60 | 2.5 | 3-4.5 | 3 |
| Blend 12 | 2.25 | — | 25 | — | — | 4.5 |

One can see from the examples that the polyurethane component containing the NMP (blends 1-3) failed to give a satisfactory fast hardness development. The improvement of the chemical resistance can be achieved with a self-crosslinking system (blend 2) while the improvement of the final hardness can be obtained with a core & shell morphology (blend 3) without detrimental effect on the film formation, but despite the lower chemical resistance.

The total suppression of the NMP in the polyurethane component improves the fast hardness (blend 4) which is still the case when a coalescing solvent is added to the product to descrease the MFFT (blend 5). But the best contribution to the fast hardness is obtained with the comparative coalescent-in-synthesis process (blend 6) that does not significantly depress the film formation and the performance of the coating on wood.

The composition of both the polyurethane and the acrylic components can be modified in large proportions in order to optimize the overall performance of the products and to influence positively the combination of antagonistic properties, like low film formation temperature and high hardness. It is shown that the use of dipropyleneglycol dimethylether (Proglyde DMM) in combination with m-xylylene diamine (MXDA) is very efficient to record a fast hardness with a stable polymer dispersion (blend 7). The decrease of the isocyanate/hydroxyl functionality is favorable to obtain a good transparency and adhesion, either when dimethylol propionic acid (blend 8) or dimethylol butanoic acid (blend 9) is used. The incorporation of trimethylolpropane provides a favorable increase of the hardness and resistance through polymer branching (blend 10). It is possible to obtain an amine-free composition by the replacement of the amine with sodium hydroxide in the polyurethane dispersion and in the acrylic latex (blend 11); the favorable effect on occupational health is balanced by a lower resistance of the film. The use of an acrylic with another backbone composition provides endless combinations with the polyurethane dispersion; the reduction of the Tg of the acrylic polymer is for instance favorable for the film formation without increasing the coalescing solvent contents, but the transparency and the solvent resistance is somewhat reduced accordingly (blend 12).

1. A composition comprising:
(A) a dispersion of a crosslinkable polyurethane polymer in aqueous medium, and obtainable from a polyurethane prepolymer which is the reaction product of:
(i) at least one polyisocyanate, and
(ii) at least one organic compound containing at least two reactive groups which can react with isocyanates, and
(iii) at least one compound which is capable to react with an isocyanate group and which contains at least one additional functional group which is susceptible either to dispersion in water and/or to a crosslinking reaction
(iv) in an oxygenated solvent selected from the coalescing agents having a higher boiling point of from 150 to 250° C., under 760 mm Hg and being chemically inert towards isocyanates during the manufacture of the polyurethane; the so obtained polyurethane prepolymer being further neutralised and dispersed in water, and optionally then reacted with a chain extender or capping agent (v) having or not remaining functional groups after the capping;
(B) a crosslinker which is a vinyl-type polymer having functional groups reactive with the functional groups of the polyurethane polymer (A).

2. A composition according to claim 1, wherein said oxygenated coalescing solvent (iv) is selected from the fully reacted alkyl or aryl esters of aromatic, aliphatic or cycloaliphatic polycarboxylic acids, the fully reacted alkyl or aryl esters of aromatic, aliphatic or cycloaliphatic polyglycols, the fully reacted alkyl or aryl ethers of aromatic, aliphatic or cycloaliphatic polyglycols, the fully reacted mixed alkyl and aryl esters and ethers of mixed aromatic, aliphatic or cycloaliphatic polyglycol-carboxylates, the unsubstituted and alkyl and aryl substituted cyclic carbonates, the unsubstitued and alkyl and aryl substituted cyclic ethers, the unsubstituted and alkyl and aryl substituted cyclic esters, the unsubstitued and alkyl and aryl substituted cyclic anhydrides.

3. A composition according to claim 2, wherein said oxygenated coalescing solvent (iv) is selected from dimethyl esters or diisobutyl esters of adipic, glutaric, succinic or phtalic acids, ethyl-3-ethoxypropionate, 2,2,4-trimethyl-1,3-pentanedioldiisobutirate, ethylene carbonate, propylene carbonate, propyleneglycol diacetate and dipropylene glycol dimethyl ether, alone or in admixture.

4. A composition according to claim 1, wherein said coalescing solvent (iv) is used in an amount of 5 to 40 weight % expressed on the dry polymers.

5. A composition according to claim 1, wherein the polyisocyanate (i) is an aliphatic, cycloaliphatic, aromatic or heterocyclic polyisocyanate or a combination thereof.

6. A composition according to claim 1 wherein the organic compound (ii) containing at least two isocyanate-reactive groups is selected from the group consisting of polyester polyols, polyether polyols, polycarbonate polyols, polyacetal polyols, polyesteramide polyols, polyacrylate polyols and polythioether polyols, alone or in admixture.

7. A composition according to claim 1, wherein the isocyanate-reactive compound (iii) contains at least one anionic salt functional group or acid group which may be subsequently converted to such anionic salt group, and is (a) a hydroxycarboxylic acid of general formula (HO)ₓR(COOH)_{y}, wherein R represents a straight or branched chain hydrocarbon radical having 1 to 12 carbon atoms, and x and y are integers from 1 to 3, or (b) a sulfonated polyester obtained by the reaction of a sulfonated dicarboxylic acid with one or more polyhydric alcohols, or by the reaction of a sulfonated diol with one or more polycarboxylic acids.

8. A composition according to claim 1, wherein the capping agent (v) is water or an aliphatic, alicyclic, aromatic or heterocyclic primary or secondary polyamine having up to 80 carbon atoms which can bear a further functional group such as in gamma-aminopropyltrimethoxysilane, gamma-aminopropyltriethoxysilane, N-beta-aminoethyl-gamma-aminopropyltrimethoxysilane, bis-(gamma-trimethoxysilylpropyl) amine and N-beta-(aminoethyl)-gamma-aminopropylmethyldimethoxysilane.

9. A composition according to claim 1, wherein the vinyl-type polymer is the product formed by the free-radical addition polymerization of at least one monoethylenically unsaturated monomer with at least one other ethylenically unsaturated monomer containing a functional group such as an acetoacetoxyalkyl ester group, carboxylic and sulfonic groups, isocyanates, hydroxy, amine, acrylic, allylic, vinyl, alkenyl, alkinyl, halogen, epoxy, aziridine, aldehyde, ketone, anhydride, carbonate, silane, carbodiimide, ureidoalkyl, N-methylolamine, N-methylolamide N-alkoxy-methyl-amine, N-alkoxy-methyl-amide, and capable to provide a crosslinking reaction with the polyurethane component.

10. A composition according to claim 9, wherein the monoethylenically unsaturated monomer containing an acetoacetoxyalkyl ester group is a compound having the formula
R¹—O—CO—CH₂—CO—CH₃
wherein R¹ represents a
CH₂═CR′13 COO—R″— group or a CH₂═CR′—R″— group in which
R′ is a hydrogen atom or a methyl radical and
R″ is an alkylene radical having 1 to 12 carbon atoms.

11. A composition according to claim 10, wherein the monoethylenically unsaturated monomer containing an acetoacetoxyalkyl ester group is acetoacetoxyethyl (meth)acrylate.

12. A composition according to claim 9, wherein the monoethylenically unsaturated monomer containing an acetoacetoxyalkyl ester group is present in an amount of from about 1 to about 80% by weight of the vinyl polymer.

13. A composition according to claim 9, wherein the monoethylenically unsaturated monomer containing an acetoacetoxyalkyl ester group is present in an amount of from about 5 to 20% by weight of the vinyl polymer.

14. A composition according to claim 9, wherein the weight ratio of said at least one polyurethane polymer to said at least one vinyl polymer is within the range of from 95:5 to 5:95.

15. A composition according to claim 1, wherein the weight ratio of said at least one polyurethane polymer to said at least one vinyl polymer is within the range of from 1:2 to 2:1.

16. A process for the preparation of an aqueous crosslinkable resin composition according to claim 1, which comprises homogenously mixing together at room temperature an aqueous dispersion of at least one polyurethane polymer and an aqueous dispersion of at least one vinyl polymer

17. A process for the preparation of an aqueous resin composition according to claim 1, which comprises subjecting the monomers of the vinyl polymer having functional groups to radical polymerisation in the presence of an polyurethane polymer having anionic salt functional groups or subjecting an isocyanate-terminated polyurethane prepolymer having anionic salt functional groups to chain-extension with a capping agent in the presence of a vinyl polymer having functional groups.

18. A protective or adhesive coating obtained with an aqueous composition according to claim 1.
